(19) United States
(12) Patent Application Publication
(10) Pub. No.: US 2019/0326673 A1
(43) Pub. Date: Oct. 24, 2019

(54) Dual Small Antennas with Feed Points Fed Out of Phase

(71) Applicant: SPAWAR Systems Center Pacific, San Diego, CA (US)

(72) Inventor: Thomas O. Jones, III, San Diego, CA (US)

(73) Assignee: United States of America as represented by Secretary of the Navy, San Diego, CA (US)

(21) Appl. No.: 15/956,873

(22) Filed: Apr. 19, 2018

(51) Int. Cl. H01Q 9/04

(52) U.S. Cl. CPC H01Q 9/0421; H01Q 1/243

(57) ABSTRACT

A system includes a rectangular parallelepiped, a first and second antenna and a driving component. The rectangular parallelepiped has a front surface, a back surface, a first side surface a second side surface, a top surface and a bottom surface. The front surface is parallel with the back surface, the first side surface is parallel with the second side surface and the top surface is parallel with the bottom surface. The first antenna and the second antenna are disposed at the top surface and are separated by a distance, d. The driving component drives the first antenna at a frequency f and at a first phase φ, and drives the second antenna at the frequency f and at a second phase φ+180°, wherein d<λ, and wherein λ is an operating wavelength of the system.

### FEDERALLY-SPONSORED RESEARCH AND DEVELOPMENT

The United States Government has ownership rights in this invention. Licensing inquiries may be directed to Office of Research and Technical Applications, Space and Naval Warfare Systems Center, Pacific, Code 72120, San Diego, Calif., 92152; telephone (619) 553-5118; email: ssc_pac_t2@navy.mil. Reference Navy Case No. 103296.

### BACKGROUND OF THE INVENTION

Embodiments of the invention relate to optimizing antenna performance.

As communication devices become smaller and smaller, incorporating an antenna into the devices has become more difficult as the antenna must become smaller as well. A patch antenna is a type of antenna that can be used on a small communication device. A patch antenna is a flat, rectangular sheet of metal mounted to a larger ground plane. One of the issues with a patch antenna is that, while it can be small, it is typically poor at transmitting and receiving signals because most of the electric field is between the underside of the patch and the ground.

A modification of a patch antenna that has been used in similar applications is a planar inverted F-antenna (PIFA). A PIFA is an inverted, F-shaped antenna that is attached to the top of a device, and it is used because it is compact and is generally better at transmitting and receiving signals than a patch antenna. The PIFA has a feed point and a wire connecting the antenna top plate to the box.

There exists a need for an antenna design that directs more radiation from the top of an antenna to maximize the effectiveness of an antenna. There exists a need for an antenna system with higher bandwidth.

### SUMMARY OF THE INVENTION

An aspect of the present invention is drawn to a system that includes a rectangular parallelepiped, a first and second antenna and a driving component. The rectangular parallelepiped has a front surface, a back surface, a first side surface, a second side surface, a top surface and a bottom surface. The front surface is parallel with the back surface, the first side surface is parallel with the second side surface and the top surface is parallel with the bottom surface. The first antenna and the second antenna are disposed at the top surface and are separated by a distance, d. The driving component drives the first antenna at a frequency f and at a first phase φ, and drives the second antenna at the frequency f and at a second phase φ+180°, wherein d˜λ/2 or smaller, and wherein λ is the operating wavelength of the system. The above concept also applies to other box shapes, edges rounded, circular, elliptical, spherical and other non-planer shapes.

### BRIEF DESCRIPTION OF THE DRAWINGS

The accompanying drawings, which are incorporated in and form a part of the specification, illustrate example embodiments and, together with the description, serve to explain the principles of the invention. In the drawings:

FIG. 1 illustrates a prior art PIFA antenna arrangement on a communication device;

FIG. 2 illustrates a graph showing the frequency band for a prior art PIFA antenna arrangement on a communication device;

FIGS. 3A-B illustrate radiation patterns from a prior art PIFA antenna arrangement at different frequencies;

FIG. 4 illustrates a PIFA antenna arrangement on a communication device in accordance with aspects of the present invention;

FIG. 5 illustrates a graph showing the frequency band for a PIFA arrangement on a communication device in accordance with aspects of the present invention; and

FIGS. 6A-B illustrate radiation patterns from a PIFA antenna arrangement at different frequencies in accordance with aspects of the present invention.

### DETAILED DESCRIPTION OF THE EMBODIMENTS

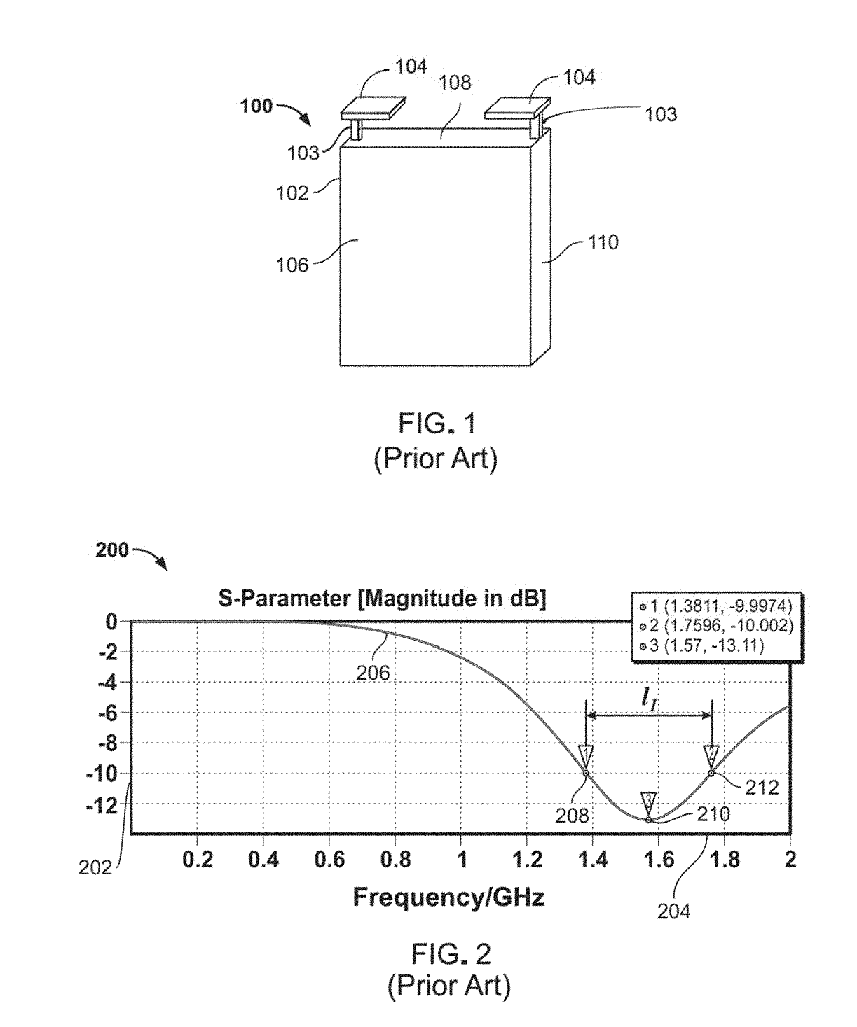

FIG. 1 illustrates a prior art PIFA antenna arrangement 100 for use with a communication device.

As shown in the figure, PIFA antenna arrangement 100 includes a box 102, a ground line 103 and an antenna 104. Box 102 includes a front 106, a top 108 and a side 110. Box 102 also includes a bottom, a back, and a second side such that box 102 resembles a rectangular parallelepiped.

Box 102 may be used with any type of wireless communication device or system, non-limiting examples of which include mobile phones, tablet computers, laptop computers, desktop computers, vehicles, Internet-connected devices, or any other device that communicates via GSM, Bluetooth, Wi-Fi, or other communication types.

Antenna 104 is attached to top 108 and provides a way for box 102 to communicate with other devices. Antenna 104 may be any type of antenna that is sized and configured to fit on box 102. As shown in FIG. 1, antenna 104 is a PIFA, however antenna 104 may be any antenna that can attach to box 102 and transmit and receive signals.

Ground line 103 provides a short from antenna 104 to the box 102.

FIG. 2 illustrates a graph showing the S11-parameter in dB as a function of frequency for PIFA antenna arrangement 100 as used with a communication device.

As shown in the figure, a graph 200 includes a y-axis 202, an x-axis 204, a function 206, a first point 208, a center frequency 210, and a second point 212. Y-axis 202 corresponds to the S-parameter and is measured in dB. The S11-parameter represents how much power is reflected from the antenna or return loss. X-axis 204 is frequency and is measured in GHz. Function 206 corresponds to the reflection coefficient of the antenna 104. Center frequency 210 is the optimal operating frequency for antenna 104, and it is at this frequency that antenna 104 performs best. However, antenna 104 operates within a frequency band such that antenna 104 is not always operating at center frequency 210.

One way in which antenna performance can be measured is the width of the frequency band around center frequency 210 in which the decibels (dB) of an antenna reach −10 dB. On FIG. 2, the measurement for antenna 104 is denoted by l_{I}, which is the width of the frequency band between first point 208 and second point 212. Generally, the larger the width of the frequency band, the better the antenna performs because more radiation is sent away from the antenna and less radiation is reflected back toward the feed point.

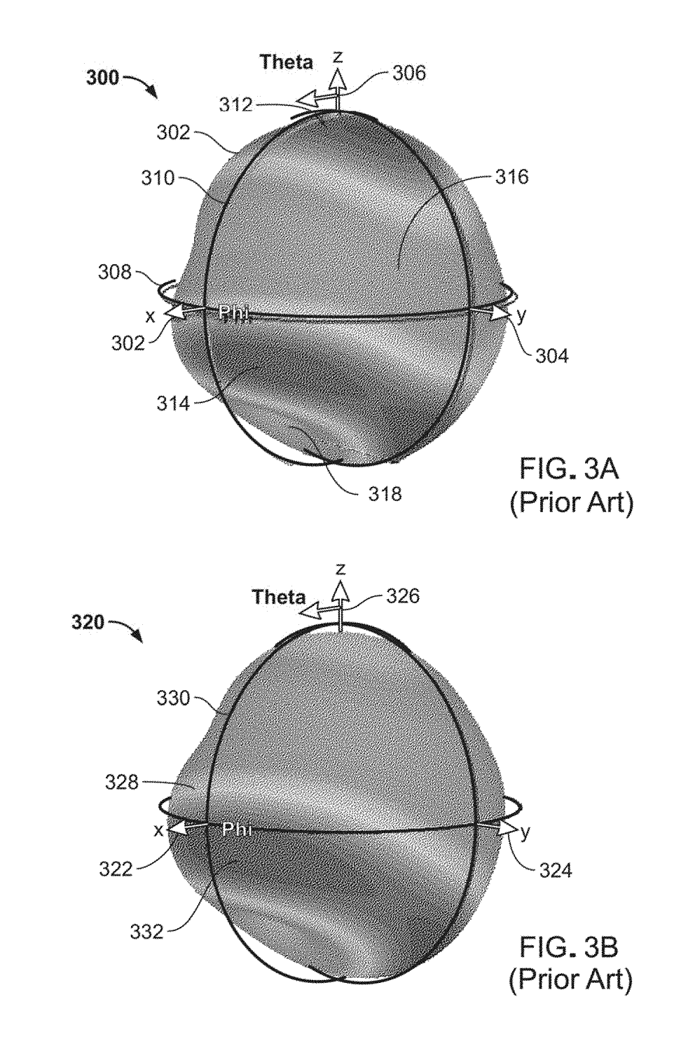

FIGS. 3A-B illustrate radiation patterns from prior art PIFA antenna arrangement 100 at different frequencies.

As shown in FIG. 3A, a radiation pattern 300 shows the pattern of radiation emitted from antenna 104 when antenna 104 is driven at a frequency of 1.65 GHz. Radiation pattern 300 is situated about PIFA antenna arrangement 100 (not shown) as it is disposed at the center of an x-axis 302, a y-axis 304 and a z-axis 306.

When PIFA antenna arrangement 100 is disposed so as to transmit such z-axis 306 is normal to top 108 (not shown), antenna 104 has a relatively high transmission efficiency in first area 312 and second area 314, but has a relatively low transmission efficiency in area third 316 and fourth area 318.

As shown in FIG. 3B, a radiation pattern 320 shows the pattern of radiation emitted from antenna 104 when antenna 104 is driven at a frequency of 1.45 GHz. Radiation pattern 320 is situated about PIFA antenna arrangement 100 (not shown) as it is disposed at the center of an x-axis 322, a y-axis 324 and a z-axis 326.

When PIFA antenna arrangement 100 is disposed so as to transmit such z-axis 326 is normal to top 108 (not shown), antenna 104 has a relatively high transmission efficiency only in area 332, but has a relatively low transmission efficiency in the remainder of the areas.

The purpose of an antenna when it is transmitting information is to transmit as much of the signal away from the transmitting device as possible such that the signal is as strong as possible. If the signal is transmitted down toward the ground, the signal reflected from the ground will be reduced in amplitude, the signal will not be as strong and may not reach the intended target. The strength of the signal can be measured by the radiation fields emitted from the antenna.

Returning to FIG. 3A, there is high radiation 306 located near first area 312, but there is also an area of high radiation in second area 314. This distribution of high radiation indicates that, at 1.65 GHz, antenna 104 is emitting radiation down toward the ground where it could be absorbed. The signal being emitted from antenna 104 is not as strong as it could be.

Turning to FIG. 3B, there is no area of high radiation normal to antenna 104—in the positive direction of z-axis 326. High radiation is only located generally in the negative direction of z-axis 326 in fourth area 332. This distribution of high radiation indicates that, at 1.45 GHz, antenna 104 is emitting radiation has a poor pattern and the signal being emitted from antenna 104 is not as strong as it could be in the desired direction.

The present invention provides a system to optimize the radiation emitted from the top of an antenna mounted on a box.

Embodiments of the present invention provide a system that includes at least two antennas attached to the top of a box. The antennas may be patch antennas, PIFA antennas, or other antennas suitable for the application. The antennas are driven at frequencies 180 degrees out of phase such that the electric field between the antennas is stronger than that generated by a single antenna. In addition to creating a stronger electric field, arranging antennas in this way directs more of the radiation out from the top of the antenna system than that radiating from the top of a single antenna system.

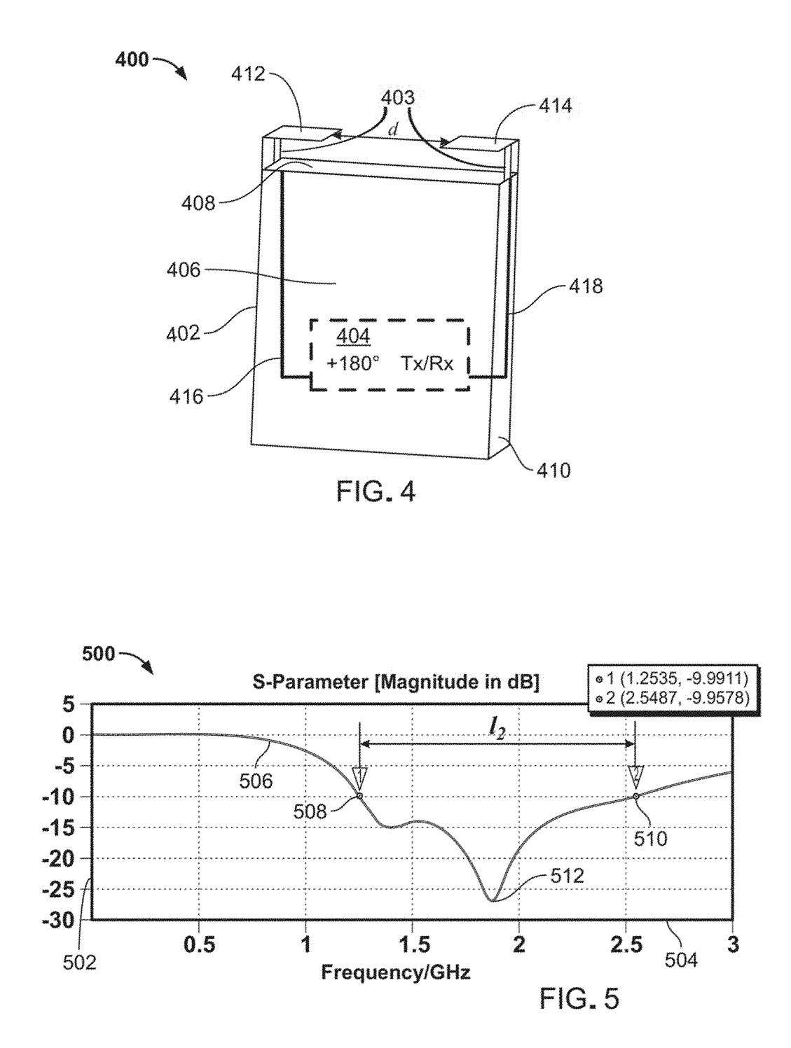

Aspects of the present invention will now be discussed with reference to FIGS. 4-6.

FIG. 4 illustrates a communication device 400 in accordance with aspects of the present invention.

As shown in the figure, communication device 400 includes a PIFA antenna arrangement 412 and 414, ground lines 403 and a transceiver 404. Transceiver 404 is disposed within PIFA arrangement 402. PIFA antenna arrangement 412 and 414 includes a front 406, a top 408, a side 410, a left antenna 412, and a right antenna 414. PIFA antenna arrangement 412 and 414 also includes a bottom, a back, and a second side such that PIFA antenna arrangement 412 and 414 resembles a rectangular parallelepiped. Transceiver 404 is connected to left antenna 412 via a communication line 416 and is connected to right antenna 414 via a communication line 418.

PIFA antenna arrangement 412 and 414 may be any type of device or system that wirelessly communicates. Non-limiting examples of PIFA antenna arrangement 412 and 414 include mobile phones, tablet computers, laptop computers, desktop computers, vehicles, Internet-connected devices, or any other device that communicates via GSM, Bluetooth, WiFi, or other communication types.

Transceiver 404 may be any known type of transceiver that is able to provide a signal to be transmitted to PIFA antenna arrangement 412 and 414 and to receive a signal from PIFA antenna arrangement 412 and 414.

Left antenna 412 and right antenna 414 are attached to top 408 and provide a way for PIFA antenna arrangement 412 and 414 to communicate with other devices. As shown in FIG. 4, left antenna 412 and right antenna 414 are PIFAs, however left antenna 412 may be any device or system that can attach to PIFA antenna arrangement 412 and 414 and transmit and receive signals effectively.

Left antenna 412 and right antenna 414 are separated by a distance d. Preferably, d is less than the operating wavelength of the system, λ. More preferably, d˜λ/2.

When transmitting, transceiver 404 generates a signal to be transmitted at a frequency f. As such, left antenna 412 and right antenna 414 are driven at the same frequency, f. To optimize the electric field strength between left antenna 412 and right antenna 414, the frequency f for one antenna will be driven at a phase co that is 180° from the phase of the other antenna. As such, the driving signal provided to left antenna 412 via communication line 416 is 180° out of phase from the driving signal provided to right antenna 414 via communication line 418. Such out-of-phase driving may be implemented with two separate transmitters (not shown) within transceiver 404, where each transmitter is driving with a separate inverted clock signal and wherein one clock signal is 180° out of phase with the other. Another non-limiting example of an out-of-phase driving implementation includes the use of a phase delay element. In any event, any known driving system for providing 180° out-of-phase driving signals may be used in transceiver 404 in accordance with aspects of the present invention.

Using this method of driving left antenna 412 and right antenna 414 when transmitting at the same frequency but opposite phases, patch antennas become more efficient and can be used in addition to the PIFAs discussed throughout. When two patch antennas are used and driven in the same manner, an electric field will be created between the top surfaces of the two patches instead of focusing the electric field on the underside of the patches. /

When receiving, transceiver 404 receives signals a frequency f, from each of left antenna 412 and right antenna 414. Transceiver 404 then process the received signals 180° out of phase in a manner analogous to the transmission discussed above.

FIG. 5 illustrates a graph showing the frequency band for a PIFA arrangement on a communication device in accordance with aspects of the present invention.

As shown in the figure, a graph 500 includes a y-axis 502, an x-axis 504, a function 506, a first point 508, a center frequency 512, and a second point 510. Function 506 corresponds to the combined operating frequency of left antenna 412 and right antenna 414. Center frequency 512 is the optimal operating frequency for the combination of left antenna 412 and right antenna 414, and it is at this frequency that the combination of left antenna 412 and right antenna 414 performs best.

The width of the frequency band is denoted by l₂, which is the width between point 508 and point 510. In comparing l₂ to l₁ from FIG. 2, l₂ is approximately three times larger than l₁, indicating that the performance of the combination of left antenna 412 and right antenna 414 is approximately 3 times better than the performance of the prior art antenna arrangement from FIG. 1.

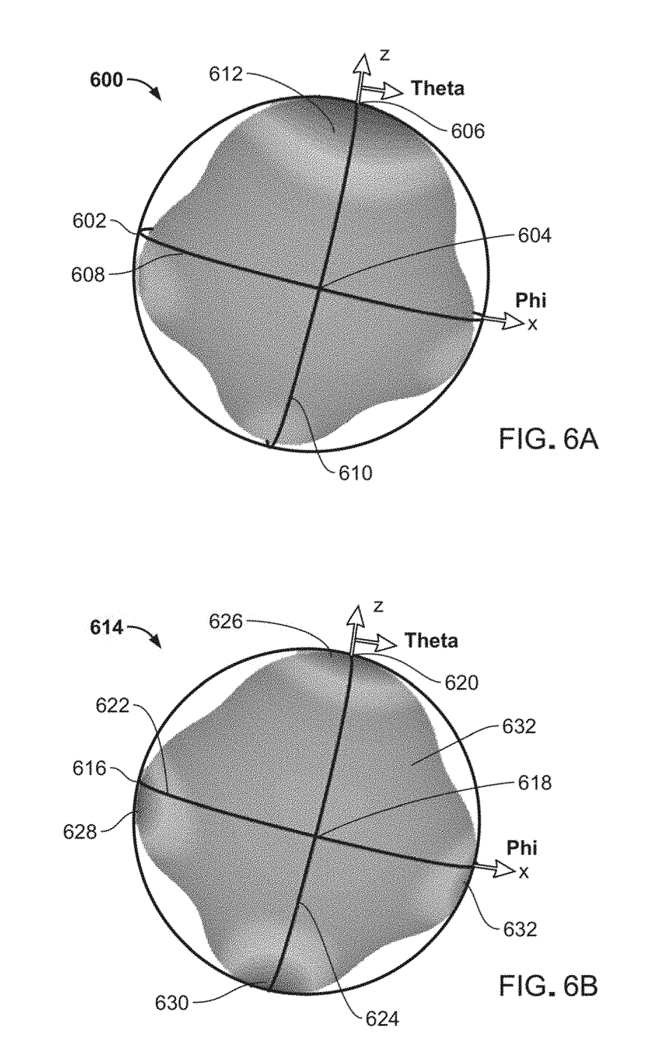

FIGS. 6A-B illustrate radiation patterns from a PIFA antenna arrangement in accordance with aspects of the present invention at different frequencies.

As shown in FIG. 6A, a radiation pattern 600 shows the pattern of radiation emitted from left antenna 412 and right antenna 414 is driven at a frequency of 1.65 GHz. Radiation pattern 600 is situated about PIFA antenna arrangement 412 and 414 (not shown) as it is disposed at the center of an x-axis 602, a y-axis 604 and a z-axis 606.

When PIFA antenna arrangement 412 and 414 is disposed so as to transmit such z-axis 606 is normal to top 408 (not shown), left antenna 412 and right antenna 414 have a relatively high transmission efficiency in an area 612, but has a relatively low transmission efficiency in all other areas.

As shown in FIG. 6B, a radiation pattern 614 shows the pattern of radiation emitted from left antenna 412 and right antenna 414 is driven at a frequency of 1.45 GHz. Radiation pattern 614 is situated about PIFA antenna arrangement 412 and 414 (not shown) as it is disposed at the center of an x-axis 616, a y-axis 618 and a z-axis 620.

When PIFA antenna arrangement 412 and 414 is disposed so as to transmit such z-axis 620 is normal to top 408 (not shown), left antenna 412 and right antenna 414 have a relatively high transmission efficiency in a top area 626, a left area 628, a bottom area 630 and a right area 632, but has a relatively low transmission efficiency in all other areas.

Comparing FIGS. 3A and 6A, it is apparent that the combination of left antenna 412 and right antenna 414 provide a more powerful and efficient signal than that provided by the prior art single antenna 104 because more radiation is directed away from PIFA antenna arrangement 412 and 414.

Turning to FIG. 6B, areas of high radiation include top area 626, left area 628, bottom area 630 and right area 632. These high radiation areas are of similar size, indicating the strength of the signal emitted from the combination of left antenna 412 and right antenna 414 is similar in those areas.

Comparing FIGS. 3B and 6B, at 1.45 GHz antenna 104 emitted much of the signal down toward antenna bottom as indicated by second area 332, whereas the combination of left antenna 412 and right antenna 414 emitted much more of the signal in the positive z-direction as indicated by area 626, indicating the combination of left antenna 412 and right antenna 414 provide a more powerful and efficient signal than that provided by the prior art single antenna 104.

The non-limiting example embodiments discussed above are drawn to small patch antennas and PIFAs. It should be noted that aspects of the present invention may be implemented with antennas in general. For example, one arm of a bow-tie antenna may be implemented, wherein a bow-tie antenna is a vertical rectangular plate or in general a fat monopole.

In summary, prior art ways of attaching an antenna to a small communication device tend to result in inefficient radiation emission patterns in which much of the radiation is directed bellow the communication device. The present invention provides a way to combine multiple antennas to a small communication device to more efficiently direct radiation away from the device and antennas. To do so, the antennas are driven at the same frequency, f, but at phases, co, that are 180° apart. Driving the antennas out of phase creates a stronger electric field between the antennas, resulting in a more powerful and more efficient signal where much of the radiation is directed away from the antennas and the communication device.

The foregoing description of various preferred embodiments have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A transmitting system comprising:
a rectangular parallelepiped having a front surface, a back surface, a first side surface a second side surface, a top surface and a bottom surface, said front surface being parallel with said back surface, said first side surface being parallel with said second side surface and said top surface being parallel with said bottom surface;
a first antenna disposed at said top surface;
a second antenna disposed at said top surface and being separated from said first antenna by a distance, d; and
a transceiver operable to drive said first antenna at a frequency f and at a first phase φ, and to drive said second antenna at the frequency f and at a second phase φ+180°,
wherein d<λ, and
wherein λ is an operating wavelength of the transmitting system.

2. The transmitting system of claim 1, wherein said first antenna comprises a patch antenna.

3. The transmitting system of claim 1, wherein the distance d˜λ.

4. The transmitting system of claim 1, wherein said first antenna comprises a planar inverted F-antenna.

5. A receiving system comprising:
a rectangular parallelepiped having a front surface, a back surface, a first side surface a second side surface, a top surface and a bottom surface, said front surface being parallel with said back surface, said first side surface being parallel with said second side surface and said top surface being parallel with said bottom surface;
a first antenna disposed at said top surface;
a second antenna disposed at said top surface and being separated from said first antenna by a distance, d; and
a transceiver operable to receive a first signal from said first antenna at a frequency f, to receive a second signal from said second antenna at the frequency f, to process the first signal at a phase φ and to process the second signal at a phase φ+180°,
wherein d<λ, and
wherein λ is an operating wavelength of the transmitting system.

6. The receiving system of claim 5, wherein said first antenna comprises a patch antenna.

7. The transmitting system of claim 5, wherein the distance d˜λ.

8. The receiving system of claim 5, wherein said first antenna comprises a planar inverted F-antenna.

9. The receiving system of claim 5, further comprising a ground line connecting said rectangular parallelepiped with said first antenna.

10. A transmitting method comprising:
providing a rectangular parallelepiped having a front surface, a back surface, a first side surface a second side surface, a top surface and a bottom surface, the front surface being parallel with the back surface, the first side surface being parallel with the second side surface and the top surface being parallel with the bottom surface;
providing a first antenna disposed at the top surface;
providing a second antenna disposed at the top surface and being separated from the first antenna by a distance, d;
driving, via a transceiver, the first antenna at a frequency f and at a first phase φ; and
driving, via the transceiver, the second antenna at the frequency f and at a second phase φ+180°,
wherein d<2, and
wherein λ is an operating wavelength of the rectangular parallelepiped, the first antenna and the second antenna.

11. The transmitting method of claim 10, wherein said providing a first antenna disposed at the top surface comprises providing the first antenna as a patch antenna.

12. The transmitting method of claim 11, wherein said providing the first antenna as a patch antenna comprises providing the patch antenna as a circular polarization patch antenna.

13. The transmitting method of claim 10, wherein said providing a first antenna disposed at the top surface comprises providing the first antenna as a planar inverted F-antenna.

14. The transmitting method of claim 10, wherein said providing a second antenna disposed at the top surface comprises providing the second antenna as a second planar inverted F-antenna.
